(19) United States
(12) Patent Application Publication
(10) Pub. No.: US 2025/0273222 A1
(43) Pub. Date: Aug. 28, 2025

(54) SOUND DATA CREATION METHOD AND SOUND DATA CREATION DEVICE

(71) Applicant: FUJIFILM Corporation, Tokyo (JP)

(72) Inventors: Kazuya OKIYAMA, Saitama-shi (JP); Mototada OTSURU, Saitama-shi (JP); Yukinori NISHIYAMA, Saitama-shi (JP)

(73) Assignee: FUJIFILM Corporation, Tokyo (JP)

(21) Appl. No.: 19/204,573

(22) Filed: May 11, 2025

Related U.S. Application Data
(63) Continuation of application No. PCT/JP2023/037766, filed on Oct. 18, 2023.

(30) Foreign Application Priority Data
Nov. 22, 2022 (JP) 2022-186835

(51) Int. Cl. G10L 19/008; H04S 1/00

(52) U.S. Cl. CPC G10L 19/008; H04S 1/007

(57) ABSTRACT

A sound data creation method of the present disclosure includes a recording step of generating and recording first sound data having a first number of bits based on a first sound signal output from a first sound collection element, and a creation step of creating, based on the first sound data, second sound data having a second number of bits, which is smaller than the first number of bits, and having directivity information.

### CROSS-REFERENCE TO RELATED APPLICATIONS

This application is a continuation application of International Application No. PCT/JP2023/037766, filed Oct. 18, 2023, the disclosure of which is incorporated herein by reference in its entirety. Further, this application claims priority from Japanese Patent Application No. 2022-186835, filed on Nov. 22, 2022, the disclosure of which is incorporated herein by reference in its entirety.

### BACKGROUND

### 1. Technical Field

The technique of the present disclosure relates to a sound data creation method and a sound data creation device.

### 2. Description of the Related Art

JP2012-073435A discloses an audio signal conversion device that samples an input analog audio signal of an L channel and an R channel with a sampling frequency of 192 KHz and a quantization bit rate of 24 bits in an A/D conversion device to generate a digital signal. A signal processing device is connected to an output side of the A/D conversion device. This signal processing device performs processing of down-sampling the frequency to ¼ (48 kHz) and processing of converting the down-sampled signal into a floating point format of a quantization bit rate of 32 bits.

JP2002-246913A discloses a data processing device that converts input data from a fixed point format to a floating point format by a conversion unit.

### SUMMARY

An object of one embodiment according to the technique of the present disclosure is to provide a sound data creation method and a sound data creation device capable of improving quality of sound data.

In order to achieve the above object, a sound data creation method of the present disclosure comprises a recording step of generating and recording first sound data having a first number of bits based on a first sound signal output from a first sound collection element, and a creation step of creating, based on the first sound data, second sound data having a second number of bits, which is smaller than the first number of bits, and having directivity information.

It is preferable that, in the recording step, a plurality of pieces of modulation sound data, which are created by performing a plurality of types of gain processing on the first sound signal, are combined to create the first sound data.

It is preferable that the first sound data is in a floating point format.

It is preferable that the second sound data is in a pulse code modulation format.

It is preferable that the first sound data is in a monaural format, and the second sound data is in a stereo format.

It is preferable that, in the creation step, the directivity information is acquired based on a plurality of second sound signals output from a plurality of second sound collection elements.

It is preferable that, in the creation step, a sound data file including the first sound data is created.

It is preferable that the second sound data is included in a moving image file created based on video data output from an imaging element.

It is preferable that the sound data file includes link information related to the moving image file.

in the creation step, the second sound data may be created from the first sound data using a machine-trained model.

It is preferable that the machine-trained model is generated by performing machine learning using a plurality of pieces of sound data for learning, which are generated by changing a sound collection direction of the first sound collection element and collecting a sound, and correct answer data of the directivity information.

A sound data creation device of the present disclosure comprises a processor, in which the processor is configured to execute a recording step of generating and recording first sound data having a first number of bits based on a first sound signal output from a first sound collection element, and a creation step of creating, based on the first sound data, second sound data having a second number of bits, which is smaller than the first number of bits, and having directivity information.

A sound data creation method of the present disclosure comprises a recording step of generating and recording first sound data having a first number of bits based on a first sound signal output from a first sound collection element, an acquisition step of acquiring device information of an output device that outputs a sound based on second sound data having a second number of bits, which is smaller than the first number of bits, created from the first sound data, and a creation step of creating the second sound data based on the first sound data and the device information.

It is preferable that the device information relates to a volume of the output device, orientation angle information of the output device, or information related to the number of channels of the output device.

It is preferable that the device information relates to the volume and the information related to the volume relates to an efficiency of the output device.

A sound data creation device of the present disclosure comprises a processor, in which the processor is configured to execute a recording step of generating and recording first sound data having a first number of bits based on a first sound signal output from a first sound collection element, an acquisition step of acquiring device information of an output device that outputs a sound based on second sound data having a second number of bits, which is smaller than the first number of bits, created from the first sound data, and a creation step of creating the second sound data based on the first sound data and the device information.

### BRIEF DESCRIPTION OF THE DRAWINGS

Exemplary embodiments according to the technique of the present disclosure will be described in detail based on the following figures, wherein:

FIG. 1 is a diagram showing an example of a configuration of an imaging apparatus according to a first embodiment,

FIG. 2 is a diagram showing an example of a configuration of a sound signal processing circuit,

FIG. 3 is a diagram conceptually showing sound signal processing,

FIG. 4 is a diagram showing an example of a functional configuration of a processor,

FIG. 5 is a diagram conceptually showing combination processing and data format conversion processing,

FIG. 6 is a diagram conceptually showing directivity information acquisition processing,

FIG. 7 is a diagram conceptually showing volume range setting processing,

FIG. 8 is a diagram conceptually showing data extraction processing,

FIG. 9 is a diagram conceptually showing conversion from a monaural format to a stereo format,

FIG. 10 is a flowchart showing an example of an operation of the imaging apparatus,

FIG. 11 is a diagram showing a modification example of the directivity information acquisition processing,

FIG. 12 is a diagram showing an example of a functional configuration of the processor according to a second embodiment,

FIG. 13 is a diagram conceptually showing an example of learning processing of a machine-trained model,

FIG. 14 is a diagram showing an example of a functional configuration of the processor according to a third embodiment,

FIG. 15 is a diagram conceptually showing data extraction processing by a data extraction unit according to the third embodiment, and

FIG. 16 is a flowchart showing an example of an operation of the imaging apparatus according to the third embodiment.

### DETAILED DESCRIPTION

An example of an embodiment according to the technique of the present disclosure will be described with reference to accompanying drawings.

First, terms used in the following description will be described.

In the following description, “AF” is an abbreviation for “auto focus”. “MF” is an abbreviation for “manual focus”. “IC” is an abbreviation for “integrated circuit”. “CPU” is an abbreviation for “central processing unit”. “RAM” is an abbreviation for “random access memory”. “CMOS” is an abbreviation for “complementary metal oxide semiconductor”.

“FPGA” is an abbreviation for “field programmable gate array”. “PLD” is an abbreviation for “programmable logic device”. “ASIC” is an abbreviation for “application specific integrated circuit”. “OVF” is an abbreviation for “optical view finder”. “EVF” is an abbreviation for “electronic view finder”. “ADC” is an abbreviation for “analog to digital converter”. “LPCM” is an abbreviation for “linear pulse code modulation”.

As an embodiment of an imaging apparatus, the technique of the present disclosure will be described by using a lens-interchangeable digital camera as an example. The technique of the present disclosure is not limited to the lens-interchangeable type, and can be employed for a lens-integrated digital camera.

### First Embodiment

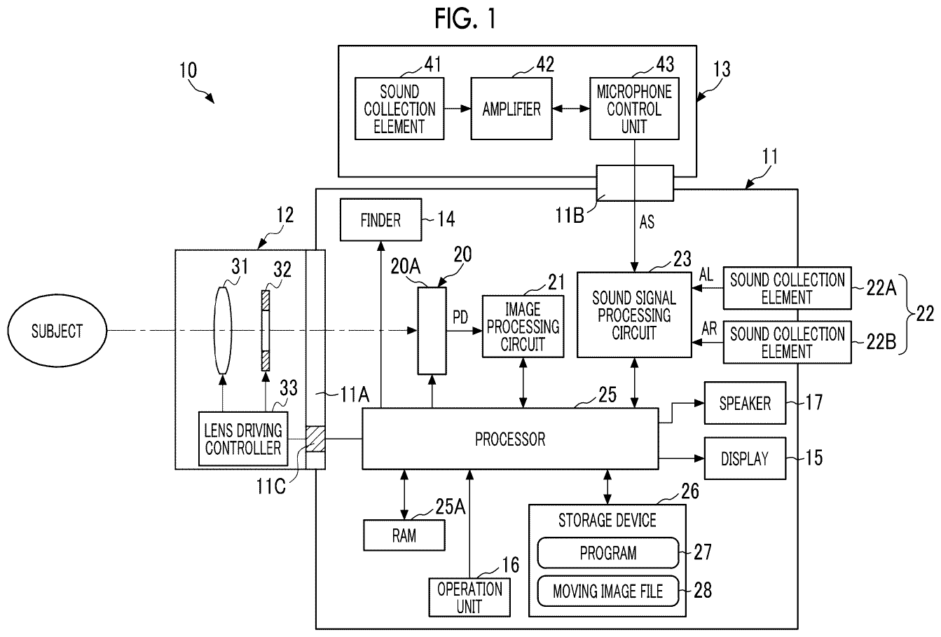

FIG. 1 shows an example of a configuration of an imaging apparatus 10 according to a first embodiment. The imaging apparatus 10 is the lens-interchangeable digital camera. The imaging apparatus 10 is configured of a housing 11 and an imaging lens 12 that is interchangeably mounted on the housing 11 and includes a focus lens 31. The imaging lens 12 is attached to a front surface side of the housing 11 via a mount 11A. The imaging apparatus 10 is an example of “sound data creation device” according to the technique of the present disclosure.

Further, an external microphone 13 can be attachably and detachably attached to the housing 11. The external microphone 13 is attached to the housing 11 via a connecting part 11B provided on an upper surface of the housing 11. The external microphone 13 is a gun microphone, a zoom microphone, or the like. The connecting part 11B is, for example, a hot shoe.

The housing 11 is provided with an operation unit 16 including a dial, a release button, and the like. Examples of an operation mode of the imaging apparatus 10 include a still image capturing mode, a video capturing mode, and an image display mode. The operation unit 16 is operated by a user in a case where the operation mode is set. Further, the operation unit 16 is operated by the user in a case where execution of still image capturing or video capturing is started.

Further, the operation unit 16 is operated by the user in a case where a focusing mode is selected. The focusing mode includes an AF mode and an MF mode. In the AF mode, a subject area selected by the user or a subject area automatically detected by the imaging apparatus 10 is set as a focus detection area (hereinafter referred to as AF area) to perform focusing control. In the MF mode, the user operates a focus ring (not shown) to manually perform the focusing control.

Further, the housing 11 is provided with a finder 14. For example, the finder 14 is a hybrid finder (registered trademark). The hybrid finder refers to, for example, a finder in which an optical view finder (hereinafter referred to as “OVF”) and an electronic view finder (hereinafter referred to as “EVF”) are selectively used. The user can observe an optical image or live view image of a subject projected onto the finder 14 via a finder eyepiece portion (not shown).

Further, a display 15 is provided on a rear surface side of the housing 11. The display 15 displays an image based on video data PD obtained by imaging, various menu screens, and the like. The user can also observe the live view image projected onto the display 15, instead of the finder 14.

Further, the housing 11 is provided with a speaker 17. The speaker 17 outputs a sound based on sound data included in a moving image file 28 described below. The speaker 17 is an example of “output device” according to the technique of the present disclosure.

The housing 11 is electrically connected to the imaging lens 12 via an electrical contact 11C provided on the mount 11A.

The imaging lens 12 includes a focus lens 31, a stop 32, and a lens driving controller 33. The lens driving controller 33 is electrically connected to a processor 25 accommodated in the housing 11, via the electrical contact 11C.

The lens driving controller 33 drives the focus lens 31 and the stop 32, based on control signals transmitted from the processor 25. The lens driving controller 33 performs drive control of the focus lens 31, based on the control signal for the focusing control that is transmitted from the processor 25, in order to adjust a position of the focus lens 31.

The stop 32 has an opening with a variable opening diameter. The lens driving controller 33 performs drive control of the stop 32, based on the control signal for stop adjustment that is transmitted from the processor 25, in order to adjust an amount of light incident on an imaging sensor 20.

Further, the imaging sensor 20, an image processing circuit 21, a built-in microphone 22, a sound signal processing circuit 23, the processor 25, and a storage device 26 are provided inside the housing 11. The processor 25 controls operations of the imaging sensor 20, the image processing circuit 21, the built-in microphone 22, the sound signal processing circuit 23, the storage device 26, the display 15, and the speaker 17.

The processor 25 is configured of, for example, a CPU. The processor 25 is connected to a RAM 25A, which is a memory for primary storage. The storage device 26 is configured of, for example, a non-volatile memory such as a flash memory. The processor 25 executes various types of processing based on a program 27 stored in the storage device 26. The processor 25 may be configured of an assembly of a plurality of IC chips. Further, for example, the storage device 26 stores the moving image file 28 generated as a result of the imaging apparatus 10 executing a video capturing operation.

The imaging sensor 20 is, for example, a CMOS-type image sensor. Light (subject image) that has passed through the imaging lens 12 is incident on a light-receiving surface 20A of the imaging sensor 20. A plurality of pixels that generate imaging signals through photoelectric conversion are formed on the light-receiving surface 20A. The imaging sensor 20 performs the photoelectric conversion on light incident on each pixel to generate and output the video data PD. The imaging sensor 20 is an example of “imaging element” according to the technique of the present disclosure.

The image processing circuit 21 performs, on the video data PD output from the imaging sensor 20, image processing including white balance correction, gamma correction processing, and the like.

The built-in microphone 22 is a stereo microphone including a pair of sound collection elements 22A and 22B. The sound collection elements 22A and 22B are sound sensors for a left side channel (hereinafter referred to as L channel) and a right side channel (hereinafter referred to as R channel). The sound collection elements 22A and 22B are sound sensors of an electrostatic type, a piezoelectric type, an electrodynamic type, or the like, and output collected sounds as sound signals AL and AR. The sound signal processing circuit 23 performs sound signal processing including gain processing, A/D conversion processing, and the like on the sound signals AL and AR output from the sound collection elements 22A and 22B. The sound collection elements 22A and 22B correspond to “plurality of second sound collection elements” according to the technique of the present disclosure. Further, the sound signals AL and AR correspond to “plurality of second sound signals” according to the technique of the present disclosure.

The external microphone 13 includes a sound collection element 41, an amplifier 42, and a microphone control unit 43. In the present embodiment, the external microphone 13 is a mono microphone having one sound collection element 41. The sound collection element 41 is a sound sensor of an electrostatic type, a piezoelectric type, an electrodynamic type, or the like, and outputs a collected sound as the sound signal. The amplifier 42 performs the gain processing on the sound signal output from the sound collection element 41. The microphone control unit 43 controls a gain amount of the gain processing by the amplifier 42. The sound collection element 41 corresponds to “first sound collection element” according to the technique of the present disclosure. Further, the sound signal output from the sound collection element 41 corresponds to “first sound signal” according to the technique of the present disclosure.

Further, the microphone control unit 43 supplies the sound signal subjected to the gain processing by the amplifier 42 to the sound signal processing circuit 23 in the housing 11 via the connecting part 11B. A mono and analog sound signal AS is supplied from the external microphone 13 to the sound signal processing circuit 23. The processor 25 controls the operation of the microphone control unit 43.

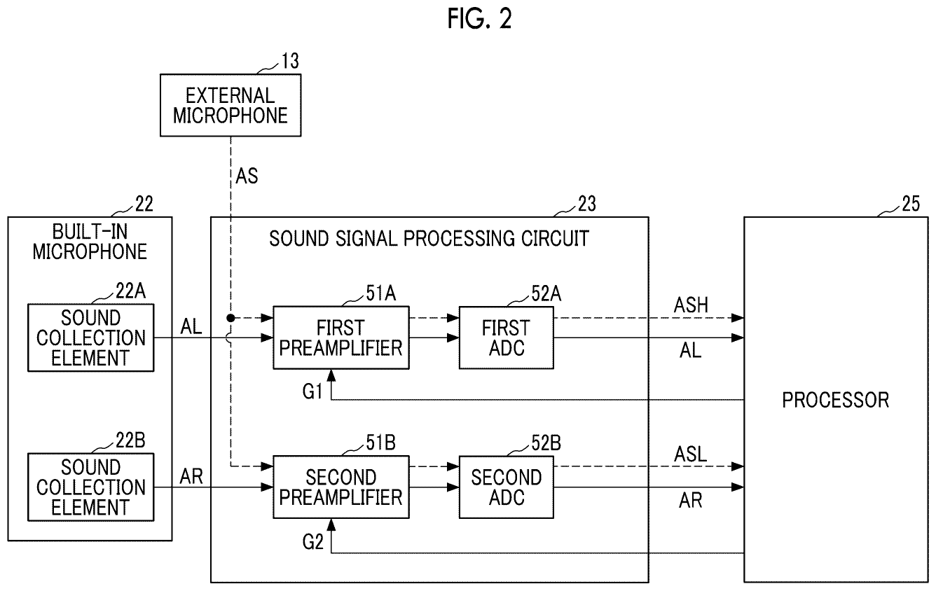

FIG. 2 shows an example of a configuration of the sound signal processing circuit 23. The sound signal processing circuit 23 includes a first preamplifier 51A, a first ADC 52A, a second preamplifier 51B, and a second ADC 52B.

The first preamplifier 51A and the first ADC 52A are processing units for L-channel that perform the gain processing and the A/D conversion processing on the sound signal AL output from the sound collection element 22A included in the built-in microphone 22. The second preamplifier 51B and the second ADC 52B are processing units for R-channel that perform the gain processing and the A/D conversion processing on the sound signal AR output from the sound collection element 22B included in the built-in microphone 22.

In the first preamplifier 51A, the processor 25 controls a gain amount G1. In the second preamplifier 51B, the processor 25 controls a gain amount G2. In a case where the gain processing is performed on the sound signals AL and AR output from the built-in microphone 22, the processor 25 sets the gain amount G1 and the gain amount G2 to the same value. The first ADC 52A and the second ADC 52B perform sampling with, for example, a quantization bit rate of 24 bits to convert an analog sound signal into a digital signal of a 24-bit LPCM format. The LPCM format is an example of “pulse code modulation format” according to the technique of the present disclosure.

The sound signal AS output from the external microphone 13 is input to the first preamplifier 51A and the second preamplifier 51B. The first preamplifier 51A performs the gain processing on the sound signal AS with the gain amount G1. The second preamplifier 51B performs the gain processing on the sound signal AS with the gain amount G2. In a case where the gain processing is performed on the sound signal AS output from the external microphone 13, the processor 25 sets the gain amount G1 and the gain amount G2 to different values. Hereinafter, the gain processing performed by the first preamplifier 51A is referred to as first gain processing, and the gain processing performed by the second preamplifier 51B is referred to as second gain processing.

The first ADC 52A converts the sound signal AS subjected to the first gain processing by the first preamplifier 51A into the digital signal. The second ADC 52B converts the sound signal AS subjected to the second gain processing by the second preamplifier 51B into the digital signal. Hereinafter, the sound signal AS digitized by the first ADC 52A is referred to as modulation sound data ASH, and the sound signal AS digitized by the second ADC 52B is referred to as modulation sound data ASL. The modulation sound data ASH and ASL are output from the sound signal processing circuit 23 to the processor 25.

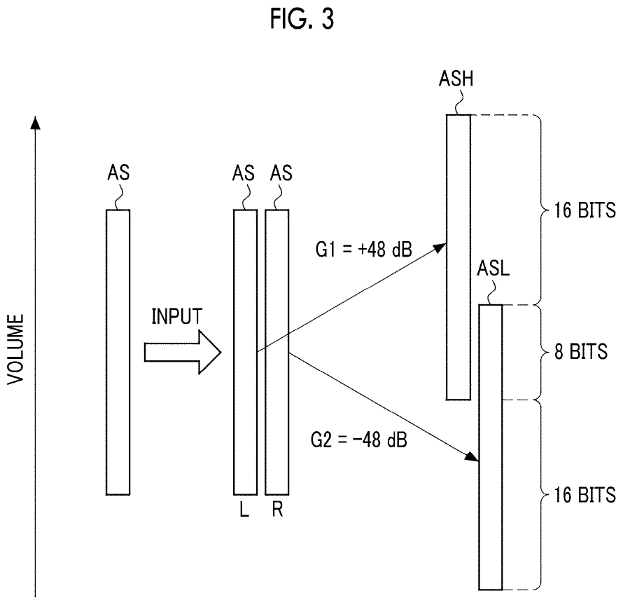

FIG. 3 conceptually shows sound signal processing of the sound signal AS by the sound signal processing circuit 23. The sound signal AS output from the external microphone 13 is input to the processing unit for L-channel and the processing unit for R-channel. The sound signal AS input to the processing unit for L-channel is subjected to the first gain processing with the gain amount G1, then is converted into the digital signal, and thus, is output from the sound signal processing circuit 23 as the modulation sound data ASH. The sound signal AS input to the processing unit for R-channel is subjected to the second gain processing with the gain amount G2, then is converted into the digital signal, and thus, is output from the sound signal processing circuit 23 as the modulation sound data ASL. In the present embodiment, the number of bits of the modulation sound data ASH and ASL is 24 bits.

For example, the gain amount G1 is assumed to be +48 dB, and the gain amount G2 is assumed to be −48 dB. Since 48 dB corresponds to a volume width of 8 bits, there is a deviation of 16 bits between the modulation sound data ASH of high gain and the modulation sound data ASL of low gain, as shown in FIG. 3. In other words, the modulation sound data ASH overlaps with the modulation sound data ASL by 8 bits.

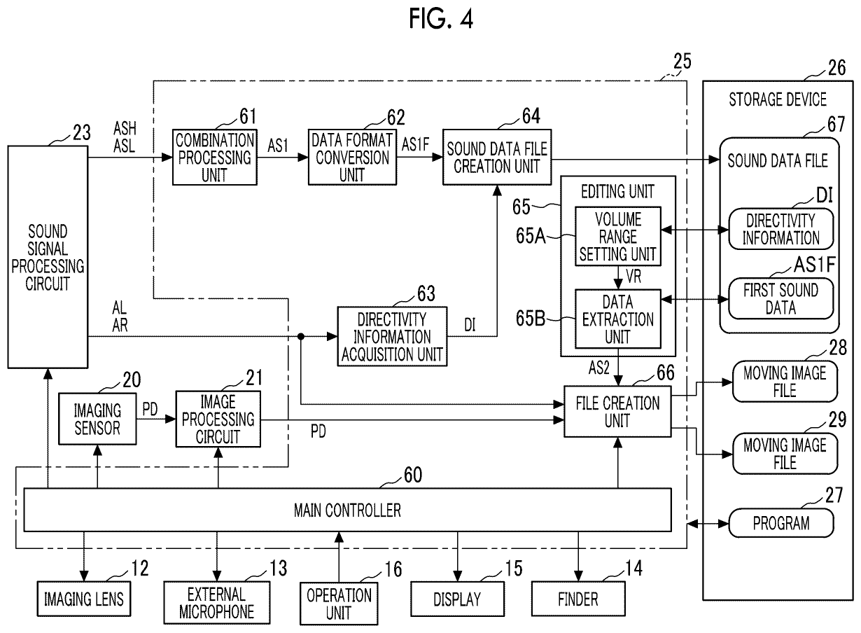

FIG. 4 shows an example of a functional configuration of the processor 25. The processor 25 executes the processing according to the program 27, which is stored in the storage device 26, to implement various functional units. Various functional units shown in FIG. 4 are implemented in the video capturing mode. As shown in FIG. 4, for example, a main controller 60, a combination processing unit 61, a data format conversion unit 62, a directivity information acquisition unit 63, a sound data file creation unit 64, an editing unit 65, and a file creation unit 66 are implemented in the processor 25. The editing unit 65 includes a volume range setting unit 65A and a data extraction unit 65B.

The main controller 60 integrally controls each unit of the imaging apparatus 10. The main controller 60 controls the operation of the imaging apparatus 10 based on an instruction signal input from the operation unit 16. The main controller 60 controls the imaging sensor 20 to cause the imaging sensor 20 to perform the imaging operation. The imaging sensor 20 outputs the video data PD, which is generated by performing the imaging via the imaging lens 12. In the video capturing mode, the imaging sensor 20 outputs the video data PD for each frame cycle. The video data PD output from the imaging sensor 20 is subjected to the image processing by the image processing circuit 21 and then input to the processor 25. In a case of the video capturing mode, the video data PD is data consisting of a plurality of frames.

Further, in the video capturing mode, in a case where the external microphone 13 is connected to the connecting part 11B, the main controller 60 controls the external microphone 13 to perform a sound collection operation. The external microphone 13 outputs the sound signal AS to the sound signal processing circuit 23 via the connecting part 11B while the imaging sensor 20 performs the imaging operation. The sound signal processing circuit 23 performs the above sound signal processing to output the modulation sound data ASH and ASL. The modulation sound data ASH and ASL correspond to the video data PD obtained by the imaging sensor 20 imaging the subject.

The combination processing unit 61 acquires the modulation sound data ASH and ASL output from the sound signal processing circuit 23, and combines the modulation sound data ASH and ASL to create first sound data AS1 having a first number of bits. The first sound data AS1 is digital data of the LPCM format.

The data format conversion unit 62 converts a data format of the first sound data AS1 into a floating point format. Hereinafter, the first sound data AS1 converted into the floating point format is referred to as first sound data ASIF.

The directivity information acquisition unit 63 acquires directivity information DI based on the pair of sound signals AL and AR, which is output from the built-in microphone 22 and subjected to the sound signal processing by the sound signal processing circuit 23. For example, the directivity information DI represents a volume difference between the L channel and the R channel.

The sound data file creation unit 64 creates a sound data file 67 including the first sound data ASIF, which is created by the data format conversion unit 62, and the directivity information DI, which is acquired by the directivity information acquisition unit 63. The sound data file creation unit 64 records the created sound data file 67 in the storage device 26.

The editing unit 65 refers to the sound data file 67 recorded in the storage device 26 to create, based on the first sound data ASIF, second sound data AS2 having a second number of bits smaller than the first number of bits and having the directivity information DI. For example, the second number of bits is 24 bits.

Specifically, the volume range setting unit 65A sets a volume range VR having a width of the second number of bits for a dynamic range of the first sound data ASIF. In the present embodiment, the volume range setting unit 65A sets the volume range VR based on the directivity information DI. The data extraction unit 65B extracts data of the volume range VR set by the volume range setting unit 65A to create the second sound data AS2, based on the first sound data ASIF. The second sound data AS2 is digital data in a stereo format and the LPCM format.

The file creation unit 66 creates the moving image file 28 including the video data PD, which is output from the image processing circuit 21, and the second sound data AS2, which is output from the data extraction unit 65B, and stores the moving image file 28 in the storage device 26. In this manner, the moving image file 28 includes the pseudo-stereo second sound data AS2, based on the directivity information DI acquired from the pair of sound signals AL and AR.

Further, the file creation unit 66 can also create a normal moving image file 29 including the video data PD, which is output from the image processing circuit 21, and the pair of sound signal AL and AR, which is output from the built-in microphone 22 and subjected to the sound signal processing by the sound signal processing circuit 23. In this manner, the pair of sound signals AL and AR used for the acquisition of the directivity information DI is included in the normal moving image file 29.

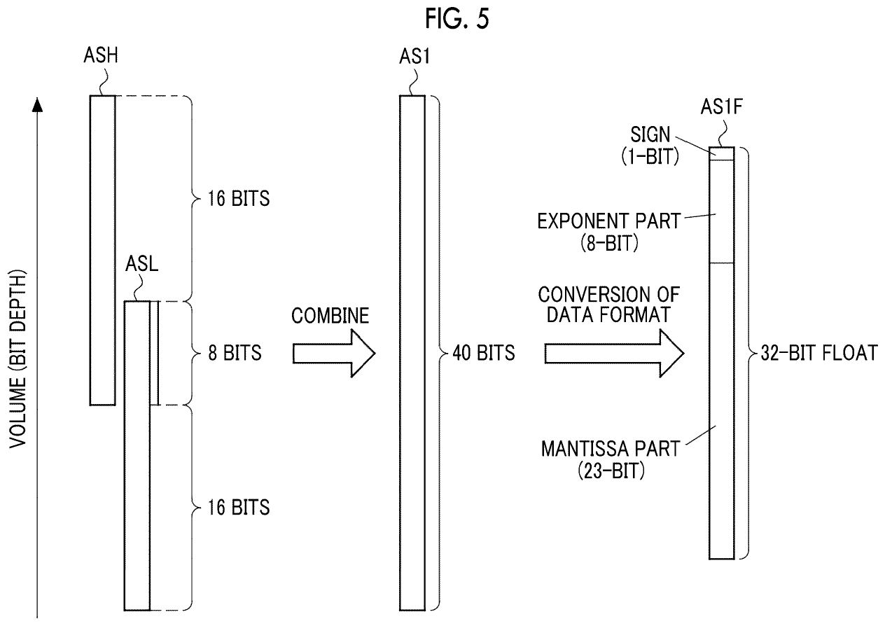

FIG. 5 conceptually shows combination processing by the combination processing unit 61 and data format conversion processing by the data format conversion unit 62. The combination processing unit 61 performs the mixing process on the overlap portion of 8 bits between the modulation sound data ASH and ASL to combine the modulation sound data ASH and the modulation sound data ASL. The number of bits (that is, the first number of bits) of the first sound data AS1, which is generated by the combination processing, is 40 bits. In this manner, with the combination of the modulation sound data ASH and ASL having different gain amounts, it is possible to obtain the first sound data AS1 with an expanded volume dynamic range.

The data format conversion unit 62 converts the first sound data AS1 of a 40-bit fixed point format into the first sound data ASIF of a 32-bit floating point format (so-called 32-bit float). The 32-bit float is configured of a 1-bit sign, an 8-bit exponent part, and a 23-bit mantissa part. A known method can be used for the conversion from the fixed point format to the floating point format. In the floating point format, a wide range of numerical values can be expressed.

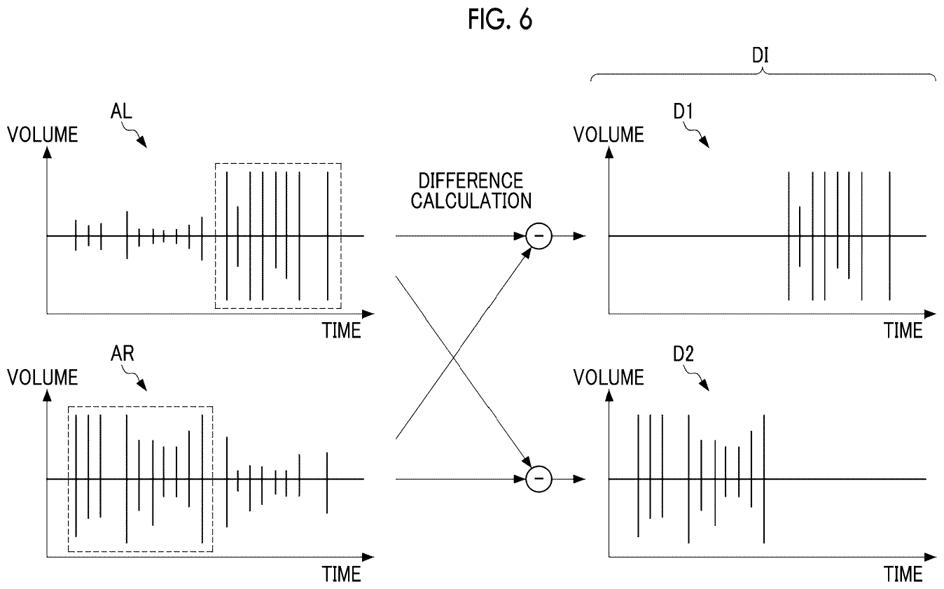

FIG. 6 conceptually shows directivity information acquisition processing by the directivity information acquisition unit 63. The sound signals AL and AR represent a change in volume (that is, change in amplitude) over time. The above directivity information DI includes first difference information D1 and second difference information D2.

The directivity information acquisition unit 63 performs a difference calculation of subtracting the sound signal AR from the sound signal AL to acquire the first difference information D1. Further, the directivity information acquisition unit 63 performs a difference calculation of subtracting the sound signal AL from the sound signal AR to acquire the second difference information D2. In the example shown in FIG. 6, the first difference information D1 includes a signal in a time region mainly surrounded by a broken line in the sound signal AL. The second difference information D2 includes a signal in a time region mainly surrounded by a broken line in the sound signal AR. The first difference information D1 represents information on a sound having a larger volume in the L channel than in the R channel. The second difference information D2 represents information on a sound having a larger volume in the R channel than in the L channel.

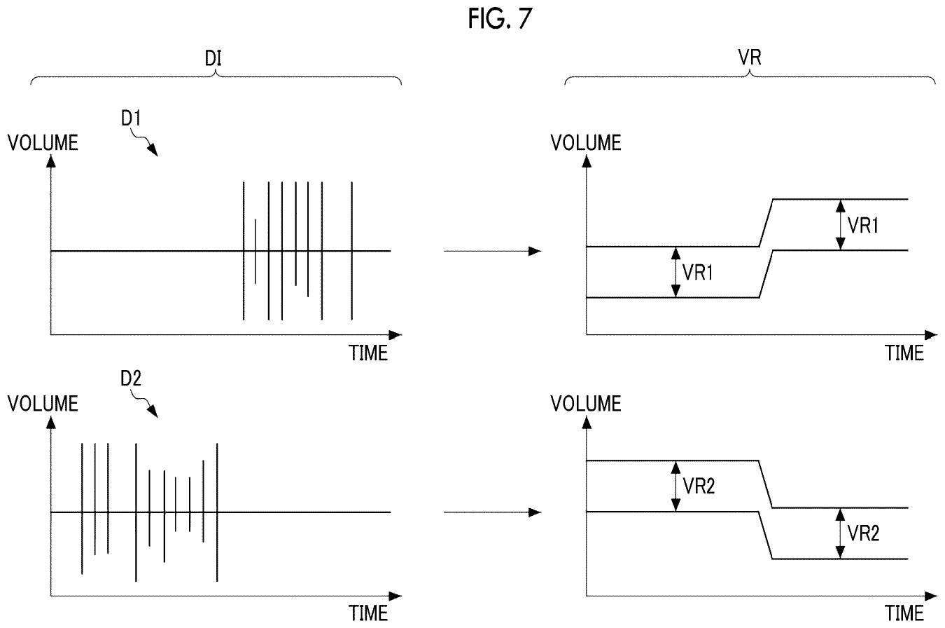

FIG. 7 conceptually shows volume range setting processing by the volume range setting unit 65A. The above volume range VR includes a first volume range VR1 and a second volume range VR2.

The volume range setting unit 65A sets the first volume range VR1 based on the first difference information D1. Specifically, the volume range setting unit 65A sets the first volume range VR1 for each time, according to the volume included in the first difference information D1. For example, the volume range setting unit 65A sets the first volume range VR1 to a high volume side as the volume included in the first difference information D1 is larger. Similarly, the volume range setting unit 65A sets the second volume range VR2 based on the second difference information D2. Specifically, the volume range setting unit 65A sets the second volume range VR2 for each time, according to the volume included in the second difference information D2. For example, the volume range setting unit 65A sets the second volume range VR2 to the high volume side as the volume included in the second difference information D2 is larger.

Thus, in a time range in which the volume is larger in the L channel than in the R channel, the first volume range VR1 is set to the high volume side. In a time range in which the volume is larger in the R channel than in the L channel, the second volume range VR2 is set to the high volume side.

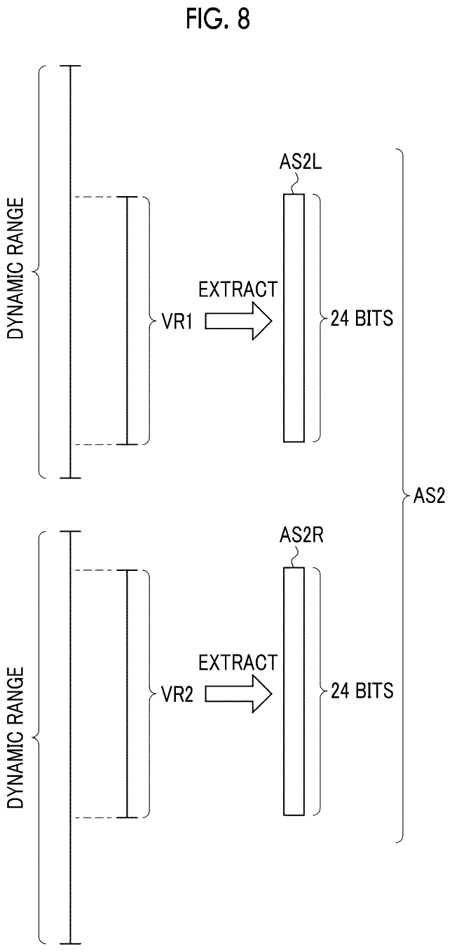

FIG. 8 conceptually shows data extraction processing by the data extraction unit 65B. The data extraction unit 65B extracts data of the first volume range VR1, based on the second first data ASIF, to create second sound data AS2L of a 24-bit fixed point format. Specifically, the data extraction unit 65B selects values of the sign and the exponent part of the 32-bit float according to the first volume range VR1 to create the second sound data AS2L of 24 bits represented by the mantissa part. Further, the data extraction unit 65B extracts data of the second volume range VR2, based on the first sound data ASIF, to create second sound data AS2R of the 24-bit fixed point format. Specifically, the data extraction unit 65B selects values of the sign and the exponent part of the 32-bit float according to the second volume range VR2 to create the second sound data AS2R of 24 bits represented by the mantissa part. The above second sound data AS2 includes the second sound data AS2L and the second sound data AS2R.

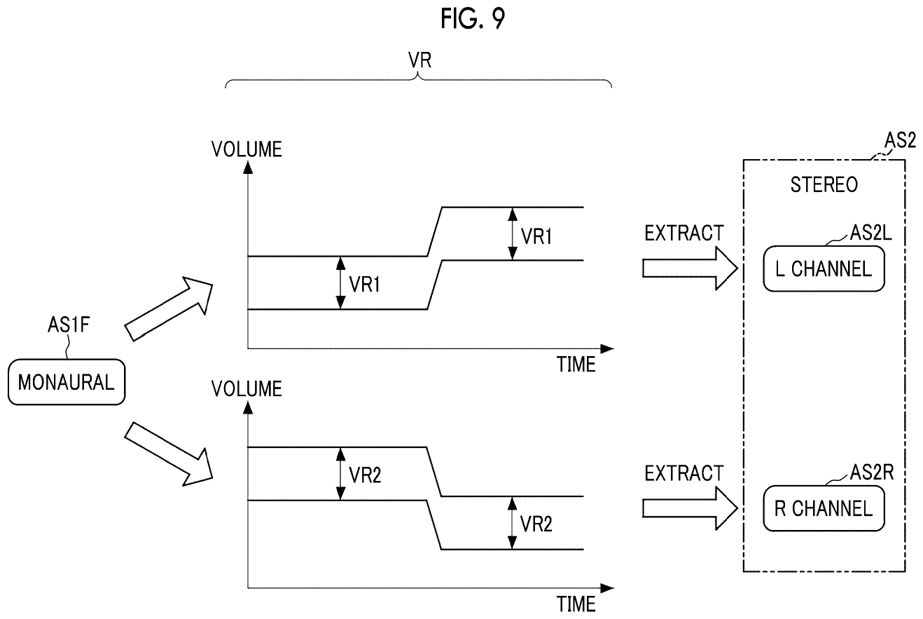

As shown in FIG. 9, the first sound data ASIF is in a monaural format. With the extraction of each of the data of the first volume range VR1 and the data of the second volume range VR2 based on the first sound data ASIF, it is possible to create the second sound data AS2 in the stereo format including the second sound data AS2L corresponding to the L channel and the second sound data AS2R corresponding to the R channel. That is, the second sound data AS2 is in the stereo format having the directivity information DI.

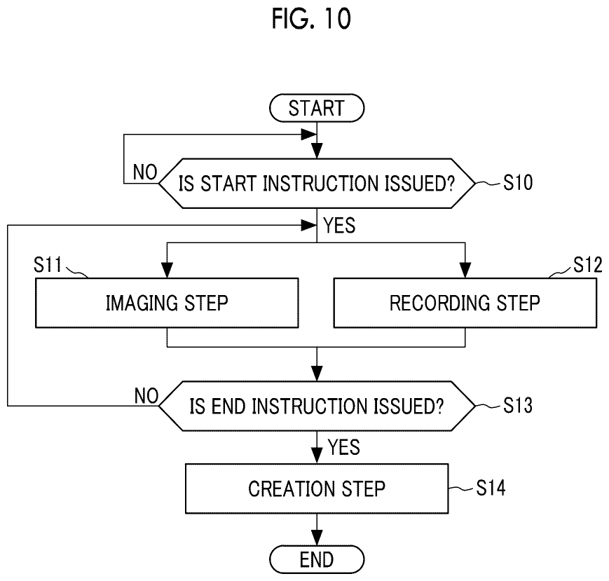

FIG. 10 is a flowchart showing an example of the operation of the imaging apparatus 10. FIG. 10 shows an operation in a case where the video capturing mode is selected as the operation mode and the external microphone 13 is connected to the connecting part 11B.

First, the main controller 60 determines whether or not the user issues a start instruction for the video capturing (step S10). In a case where the start instruction is determined to be issued (YES in step S10), an imaging step (step S11) and a recording step (step S12) are executed in parallel. In the imaging step, the imaging sensor 20 images the subject to generate the video data PD. In the recording step, the external microphone 13 and the built-in microphone 22 collect the sound. Further, in the recording step, the first sound data AS1 having the first number of bits is created based on the sound signal output from the sound collection element 41 of the external microphone 13. In the present embodiment, the first sound data AS1 is converted into the first sound data ASIF in the floating point format. Further, in the recording step, the directivity information DI is acquired based on the sound signals AL and AR output from the pair of sound collection elements 22A and 22B of the built-in microphone 22. Furthermore, the sound data file 67 including the first sound data ASIF and the directivity information DI is created and recorded in the storage device 26.

After the imaging step and the recording step, the main controller 60 determines whether or not the user issues an end instruction for the video capturing (step S13). In a case where the end instruction is determined to be not issued (NO in step S13), the processing returns to steps S11 and S12. Steps S11 to S12 are repeatedly executed until the end instruction is determined to be issued in step S13.

In a case where the end instruction is determined to be issued (YES in step S13), a creation step is executed (step S14). In the creation step, the sound data file 67 recorded in the storage device 26 is read out, and the second sound data AS2 having the second number of bits, which is smaller than the first number of bits, and having the directivity information DI is created based on the first sound data ASIF. Further, in the creation step, the moving image file 28 including the video data PD and the second sound data AS2 is created and recorded in the storage device 26. The operation of the imaging apparatus 10 is ended as described above.

As described above, a sound data creation method of the present disclosure includes the recording step of generating and recording the first sound data having the first number of bits, based on the sound signal output from the first sound collection element, and the creation step of creating, based on the first sound data, the second sound data having the second number of bits, which is smaller than the first number of bits, and having the directivity information. Accordingly, it is possible to improve quality of the sound data.

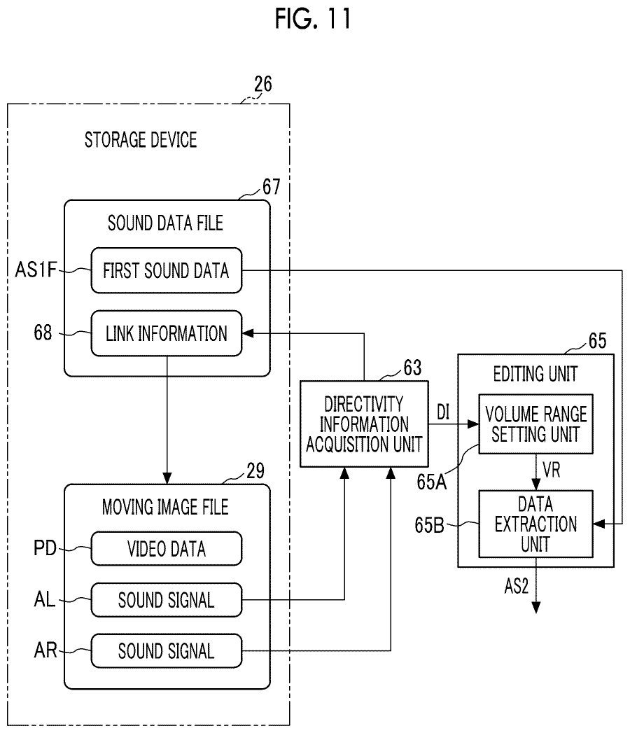

In the above embodiment, the directivity information acquisition unit 63 acquires the directivity information DI based on the sound signals AL and AR, which are input from the image processing circuit 21 to the processor 25. However, the directivity information DI may be acquired based on the sound signals AL and AR, which are included in the moving image file 29. In this case, it is preferable that the sound data file 67 includes the first sound data ASIF and link information 68 related to the moving image file 29, as shown in FIG. 11. The link information 68 represents a link destination of the moving image file 29. For example, the link information 68 is address information of the moving image file 29, file name information of the moving image file 29, and the like.

As shown in FIG. 11, the directivity information acquisition unit 63 supplies, to the volume range setting unit 65A of the editing unit 65, the directivity information DI acquired based on the sound signals AL and AR included in the moving image file 29. The processing by the editing unit 65 is the same as that in the above embodiment.

Further, in the above embodiment, the built-in microphone 22 comprises the pair of sound collection elements 22A and 22B, but the number of sound collection elements is not limited to two. The built-in microphone 22 may comprise three or more sound collection elements. That is, the directivity information acquisition unit 63 may acquire the directivity information DI of three or more channels, based on three or more sound signals output from the built-in microphone 22. In this case, the second sound data AS2 is multi-channel sound data. Further, the built-in microphone 22 may be a digital microphone that outputs the sound signals AL and AR in a digital format.

### Second Embodiment

Next, a second embodiment will be described. In the first embodiment, the first sound data ASIF of the monaural format is converted into the second sound data AS2 of the stereo format, using the directivity information DI acquired by the directivity information acquisition unit 63. In the second embodiment, the directivity information acquisition unit 63 is not provided, and the first sound data ASIF of the monaural format is converted into the second sound data AS2 of the stereo format using a machine-trained model.

The configuration of the imaging apparatus 10 according to the second embodiment other than the processor 25 is the same as that of the first embodiment. In the following, the same reference numerals are assigned to the same components as those in the first embodiment, and the description thereof will be omitted as appropriate.

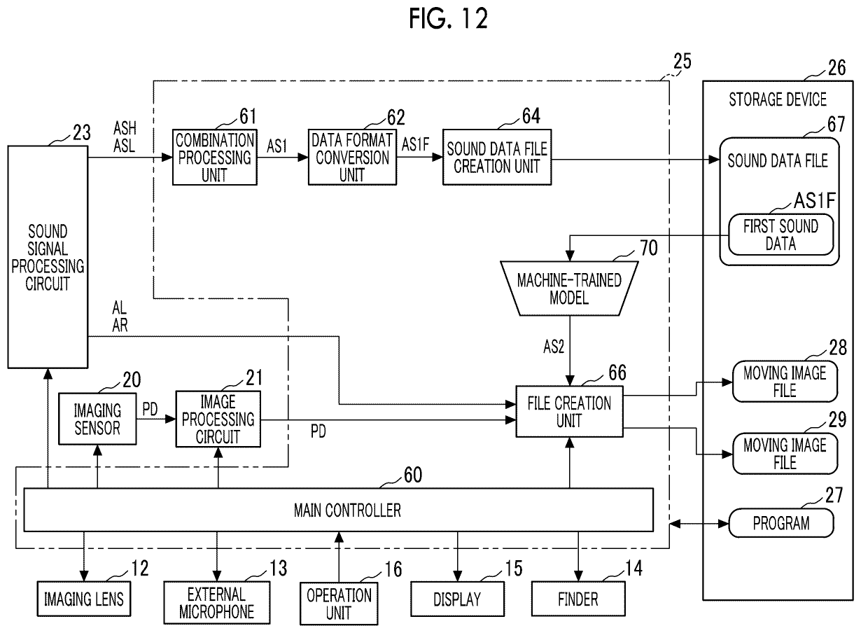

FIG. 12 shows an example of a functional configuration of the processor 25 according to the second embodiment. In the present embodiment, the main controller 60, the combination processing unit 61, the data format conversion unit 62, the sound data file creation unit 64, and a machine-trained model 70 are implemented in the processor 25. In the present embodiment, the directivity information acquisition unit 63 is not configured in the processor 25. Thus, the sound data file creation unit 64 creates the sound data file 67 including only the first sound data ASIF created by the data format conversion unit 62 and records the sound data file 67 in the storage device 26.

The main controller 60 reads out the first sound data ASIF from the sound data file 67 recorded in the storage device 26 and inputs the first sound data ASIF to the machine-trained model 70. The machine-trained model 70 is, for example, a neural network subjected to machine learning by deep learning. The machine-trained model 70 converts the input first sound data ASIF of the monaural format into the second sound data AS2 of the stereo format, and outputs the second sound data AS2.

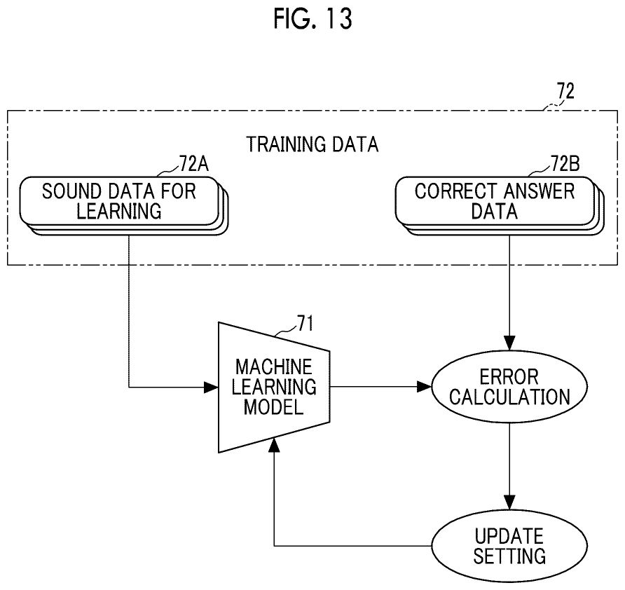

FIG. 13 conceptually shows an example of learning processing of the machine-trained model 70. As shown in FIG. 13, a machine learning model 71 is caused to be subjected to the machine learning using training data 72 in a learning phase to generate the machine-trained model 70. The training data 72 is configured of a set of a plurality of pieces of sound data for learning 72A and a plurality of correct answer data 72B. For example, the sound data for learning 72A is generated by changing a sound collection direction of the sound collection element 41 and collecting the sound. For example, the correct answer data 72B is correct answer data of the directivity information.

For the machine learning model 71, the machine learning is performed by using, for example, an error back propagation method. In the learning phase, an error calculation and update setting are repeatedly performed. In the error calculation, an error between the directivity information, which is included in the sound data output from the machine learning model 71, and the correct answer data 72B, as a result of inputting the sound data for learning 72A to the machine learning model 71. The update setting is processing of setting a weight and a bias in the machine learning model 71 such that the error is small. The machine learning on the machine learning model 71 is performed, for example, by an information processing apparatus outside the imaging apparatus 10. The machine learning model 71 subjected to the machine learning is stored in the storage device 26 of the imaging apparatus 10 as the above machine-trained model 70. The machine-trained model 70 stored in the storage device 26 is used by the processor 25.

### Third Embodiment

Next, a third embodiment will be described. In the first embodiment, the editing unit 65 creates the second sound data AS2 based on the first sound data ASIF and the directivity information DI. In the third embodiment, the second sound data AS2 is created based on the first sound data ASIF and device information of the speaker 17.

The configuration of the imaging apparatus 10 according to the third embodiment other than the processor 25 is the same as that of the first embodiment. In the following, the same reference numerals are assigned to the same components as those in the first embodiment, and the description thereof will be omitted as appropriate.

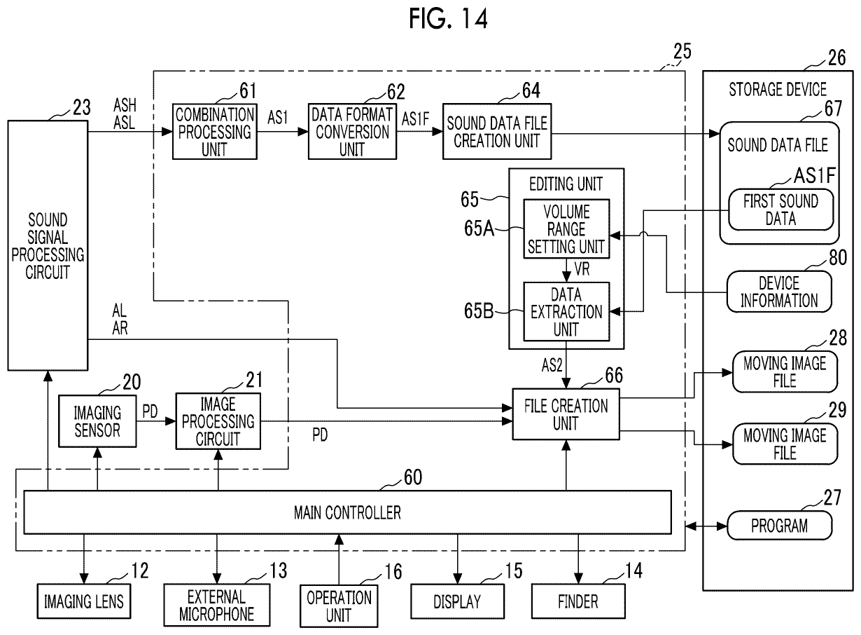

FIG. 14 shows an example of a functional configuration of the processor 25 according to the third embodiment. In the present embodiment, the main controller 60, the combination processing unit 61, the data format conversion unit 62, the sound data file creation unit 64, and the editing unit 65 are implemented in the processor 25. In the present embodiment, the directivity information acquisition unit 63 is not configured in the processor 25. Thus, the sound data file creation unit 64 creates the sound data file 67 including only the first sound data ASIF created by the data format conversion unit 62 and records the sound data file 67 in the storage device 26.

The storage device 26 stores device information 80 of the speaker 17. The device information 80 relates to characteristics of the speaker 17. For example, the device information 80 is information related to the volume of the speaker 17, orientation angle information of the speaker 17, or information related to the number of channels of the speaker 17. Further, for example, the information related to the volume of the speaker 17 relates to an efficiency of the speaker 17. The efficiency is represented by a sound pressure (dB) at a place one meter away from the speaker 17 in a case where a signal power of 1 W is input to the speaker 17. The orientation angle is represented by an angle to a place where the sound pressure is reduced by 6 dB with the sound pressure directly below the speaker 17 as a reference.

In the present embodiment, the volume range setting unit 65A acquires the device information 80 from the storage device 26, and sets the volume range VR based on the acquired device information 80. For example, the volume range setting unit 65A sets the volume range VR to the high volume side as the efficiency of the speaker 17 is higher. Further, the volume range setting unit 65A sets the volume range VR to the high volume side as the orientation angle of the speaker 17 is larger. Furthermore, the volume range setting unit 65A sets the volume range VR to the high volume side as the number of channels of the speaker 17 is larger.

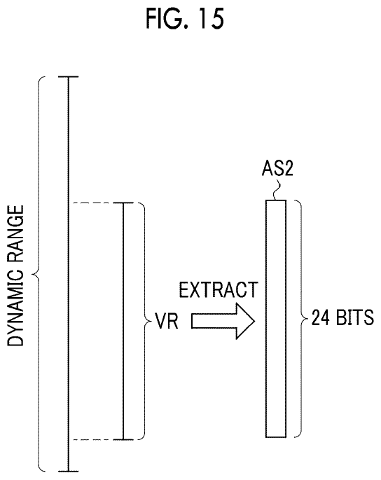

FIG. 15 conceptually shows the data extraction processing by the data extraction unit 65B according to the third embodiment. In the present embodiment, the data extraction unit 65B extracts the data of the volume range VR to create the second sound data AS2 of the 24-bit fixed point format, based on the first sound data ASIF. In the present embodiment, the second sound data AS2 is in the monaural format.

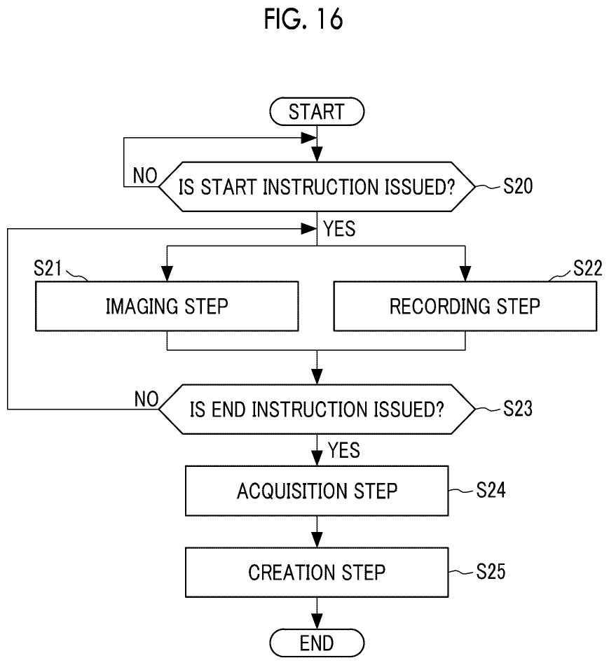

FIG. 16 is a flowchart showing an example of the operation of the imaging apparatus 10 according to the third embodiment. FIG. 16 shows an operation in a case where the video capturing mode is selected as the operation mode and the external microphone 13 is connected to the connecting part 11B.

First, the main controller 60 determines whether or not the user issues the start instruction for the video capturing (step S20). In a case where the start instruction is determined to be issued (YES in step S20), the imaging step (step S21) and the recording step (step S22) are executed in parallel. In the imaging step, the imaging sensor 20 images the subject to generate the video data PD. In the recording step, the external microphone 13 collects the sound. Further, in the recording step, the first sound data AS1 having the first number of bits is created based on the sound signal output from the sound collection element 41 of the external microphone 13. In the present embodiment, the first sound data AS1 is converted into the first sound data ASIF in the floating point format. Furthermore, the sound data file 67 including the first sound data ASIF is created and recorded in the storage device 26.

After the imaging step and the recording step, the main controller 60 determines whether or not the user issues the end instruction for the video capturing (step S23). In a case where the end instruction is determined to be not issued (NO in step S23), the processing returns to steps S21 and S22. Steps S21 to S22 are repeatedly executed until the end instruction is determined to be issued in step S23.

In a case where the end instruction is determined to be issued (YES in step S23), the acquisition step is executed (step S24). In the acquisition step, the volume range setting unit 65A acquires the device information 80 from the storage device 26. The volume range setting unit 65A sets the volume range VR based on the acquired device information 80.

After the acquisition step, the creation step is performed (step S25). In the creation step, the data extraction unit 65B extracts the data of the volume range VR to create the second sound data AS2, based on the first sound data ASIF. Further, in the creation step, the moving image file 28 including the video data PD and the second sound data AS2 is created and recorded in the storage device 26. The operation of the imaging apparatus 10 is ended as described above.

### Modification Example

The technique of the present disclosure is not limited to the digital camera and can also be employed for electronic devices such as a smartphone and a tablet terminal having an imaging function.

In each of the above embodiments, various processors shown below can be used as the hardware structure of the control unit using the processor 25 as an example. The above various processors include not only a CPU which is a general-purpose processor that functions by executing software (programs) but also a processor that has a changeable circuit configuration after manufacturing, such as an FPGA. The FPGA includes a dedicated electrical circuit that is a processor which has a dedicated circuit configuration designed to execute specific processing, such as PLD or ASIC, and the like.

The control unit may be configured by one of these various processors or a combination of two or more of the processors of the same type or different types (for example, a combination of a plurality of FPGAs or a combination of a CPU and an FPGA). Alternatively, a plurality of control units may be configured with one processor.

A plurality of examples in which a plurality of control units are configured as one processor can be considered. As a first example, there is an aspect in which one or more CPUs and software are combined to configure one processor and the processor functions as a plurality of control units, as represented by a computer such as a client and a server. As a second example, there is an aspect in which a processor that implements the functions of the entire system, which includes a plurality of control units, with one IC chip is used, as represented by system on chip (SOC). In this manner, the control unit can be configured by using one or more of the above various processors as the hardware structure.

Furthermore, more specifically, it is possible to use an electrical circuit in which circuit elements such as semiconductor elements are combined, as the hardware structure of these various processors.

Contents described and illustrated above are for detailed description of a portion according to the technique of the present disclosure and are only an example of the technique of the present disclosure. For example, the descriptions regarding the configurations, the functions, the actions, and the effects are descriptions regarding an example of the configurations, the functions, the actions, and the effects of the part according to the technique of the present disclosure. Accordingly, in the contents described and the contents shown hereinabove, it is needless to say that removal of an unnecessary part, or addition or replacement of a new element may be employed within a range not departing from the gist of the present technique of the present disclosure. Furthermore, to avoid confusion and to facilitate understanding of a part according to the technique of the present disclosure, description relating to common technical knowledge and the like that does not require particular description to enable implementation of the technique of the present disclosure is omitted from the content of the above description and from the content of the drawings.

In a case where all of documents, patent applications, and technical standard described in the specification are built into the specification as references, to the same degree as a case where the incorporation of each of documents, patent applications, and technical standard as references is specifically and individually noted.

The following technique can be understood from the above description.

### [Supplementary Note 1]

A sound data creation method comprising:
a recording step of generating and recording first sound data having a first number of bits based on a first sound signal output from a first sound collection element; and
a creation step of creating, based on the first sound data, second sound data having a second number of bits, which is smaller than the first number of bits, and having directivity information.

### [Supplementary Note 2]

The sound data creation method according to supplementary note 1,
wherein, in the recording step, a plurality of pieces of modulation sound data, which are created by performing a plurality of types of gain processing on the first sound signal, are combined to create the first sound data.

### [Supplementary Note 3]

The sound data creation method according to Supplementary Note 1 or 2,
wherein the first sound data is in a floating point format.

### [Supplementary Note 4]

The sound data creation method according to any one of supplementary notes 1 to 3,
wherein the second sound data is in a pulse code modulation format.

### [Supplementary Note 5]

The sound data creation method according to any one of Supplementary Notes 1 to 4,
wherein the first sound data is in a monaural format, and the second sound data is in a stereo format.

### [Supplementary Note 6]

The sound data creation method according to any one of supplementary notes 1 to 5,
wherein, in the creation step, the directivity information is acquired based on a plurality of second sound signals output from a plurality of second sound collection elements.

### [Supplementary Note 7]

The sound data creation method according to Supplementary Note 6,
wherein, in the creation step, a sound data file including the first sound data is created.

### [Supplementary Note 8]

The sound data creation method according to Supplementary Note 7,
wherein the second sound data is included in a moving image file created based on video data output from an imaging element.

### [Supplementary Note 9]

The sound data creation method according to supplementary note 8,
wherein the sound data file includes link information related to the moving image file.

### [Supplementary Note 10]

The sound data creation method according to any one of supplementary notes 1 to 5,
wherein, in the creation step, the second sound data is created from the first sound data using a machine-trained model.

### [Supplementary Note 11]

The sound data creation method according to Supplementary Note 10,
wherein the machine-trained model is generated by performing machine learning using a plurality of pieces of sound data for learning, which are generated by changing a sound collection direction of the first sound collection element and collecting a sound, and correct answer data of the directivity information.

What is claimed is:

1. A sound data creation method comprising:
a recording step of generating and recording first sound data having a first number of bits based on a first sound signal output from a first sound collection element; and
a creation step of creating, based on the first sound data, second sound data having a second number of bits, which is smaller than the first number of bits, and having directivity information.

2. The sound data creation method according to claim 1,
wherein, in the recording step, a plurality of pieces of modulation sound data, which are created by performing a plurality of types of gain processing on the first sound signal, are combined to create the first sound data.

3. The sound data creation method according to claim 2,
wherein the first sound data is in a floating point format.

4. The sound data creation method according to claim 3,
wherein the second sound data is in a pulse code modulation format.

5. The sound data creation method according to claim 1,
wherein the first sound data is in a monaural format, and the second sound data is in a stereo format.

6. The sound data creation method according to claim 1,
wherein, in the creation step, the directivity information is acquired based on a plurality of second sound signals output from a plurality of second sound collection elements.

7. The sound data creation method according to claim 6,
wherein, in the creation step, a sound data file including the first sound data is created.

8. The sound data creation method according to claim 7,
wherein the second sound data is included in a moving image file created based on video data output from an imaging element.

9. The sound data creation method according to claim 8,
wherein the sound data file includes link information related to the moving image file.

10. The sound data creation method according to claim 1,
wherein, in the creation step, the second sound data is created from the first sound data using a machine-trained model.

11. The sound data creation method according to claim 10,
wherein the machine-trained model is generated by performing machine learning using a plurality of pieces of sound data for learning, which are generated by changing a sound collection direction of the first sound collection element and collecting a sound, and correct answer data of the directivity information.

12. A sound data creation device comprising:
a processor,
wherein the processor is configured to execute
a recording step of generating and recording first sound data having a first number of bits based on a first sound signal output from a first sound collection element, and
a creation step of creating, based on the first sound data, second sound data having a second number of bits, which is smaller than the first number of bits, and having directivity information.

13. A sound data creation method comprising:
a recording step of generating and recording first sound data having a first number of bits based on a first sound signal output from a first sound collection element;
an acquisition step of acquiring device information of an output device that outputs a sound based on second sound data having a second number of bits, which is smaller than the first number of bits, created from the first sound data; and
a creation step of creating the second sound data based on the first sound data and the device information.

14. The sound data creation method according to claim 13,
wherein the device information relates to a volume of the output device, orientation angle information of the output device, or information related to the number of channels of the output device.

15. The sound data creation method according to claim 14,
wherein the device information relates to the volume, and
the information related to the volume relates to an efficiency of the output device.

16. A sound data creation device comprising:
a processor,
wherein the processor is configured to execute
a recording step of generating and recording first sound data having a first number of bits based on a first sound signal output from a first sound collection element,
an acquisition step of acquiring device information of an output device that outputs a sound based on second sound data having a second number of bits, which is smaller than the first number of bits, created from the first sound data, and
a creation step of creating the second sound data based on the first sound data and the device information.
